(19) United States
(12) Patent Application Publication
(10) Pub. No.: US 2026/0108841 A1
(43) Pub. Date: Apr. 23, 2026

(54) SYSTEM AND METHOD FOR SEPARATING CO2 FROM FLUE GAS

(71) Applicant: Christopher E. SCHIMP, Eldorado, IL (US)

(72) Inventor: Christopher E. SCHIMP, Eldorado, IL (US)

(21) Appl. No.: 19/353,833

(22) Filed: Oct. 9, 2025

Related U.S. Application Data
(60) Provisional application No. 63/708,316, filed on Oct. 17, 2024.

(51) Int. Cl. B01D 53/047; B01D 53/053; B01D 53/26

(52) U.S. Cl. CPC B01D 53/0476; B01D 53/053; B01D 53/261; B01D 2257/104; B01D 2257/504; B01D 2259/40007

(57) ABSTRACT

This disclosure relates to systems and methods for removing CO2 from flue gas. The system includes a first heat exchanger for receiving and cooling the flue gas, a compressor for increasing the pressure of the cooled gas, a second heat exchanger to further cool the compressed gas, and a drying unit for removing water from the cooled compressed gas. The system further includes a pressure swing adsorption unit for adsorbing CO2 from the dried, cooled compressed gas using an adsorption media, the adsorption unit comprising a vacuum compressor for pulling the CO2 off the adsorption media. A compressor may be used for extracting the CO2 from the tank and boosting the pressure of the CO2 gas.

### TECHNICAL FIELD

The present disclosure is generally directed to systems and methods for separating carbon dioxide (CO2) from flue gas.

### BACKGROUND

Under current legislation, many coal power plants will be required to substantially remove and sequester any carbon dioxide from their flue stack emissions. One goal is to remove the CO2 from the flue gas with the CO2 being 95% pure with less than 10ppm of oxygen.

The goal is to provide a CO2 removal system for the flue gas of coal fired power plants to meet the requirements for CO2 sequestration where the power consumption is equal to or less than 10% of their total power generation.

### BRIEF DESCRIPTION OF DRAWINGS

To facilitate further description of the embodiments, the following drawings are provided, in which like references are intended to refer to like or corresponding parts, and in which:

FIG. 1 is a schematic view of a system for separating CO2 from flue gas; and

FIG. 2 graphically represents a method for producing a fuel product from a source of organic matter.

For simplicity and clarity of illustration, the drawing figures illustrate the general manner of construction, and descriptions and details of well-known features and techniques may be omitted to avoid unnecessarily obscuring the present disclosure. Additionally, elements in the drawing figures are not necessarily drawn to scale. For example, the dimensions of some of the elements in the figures may be exaggerated relative to other elements to help improve understanding of embodiments of the present disclosure. The same reference numerals in different figures denote the same elements.

The terms “include,” and “have,” and any variations thereof, are intended to cover a non-exclusive inclusion, such that a process, method, system, article, device, or apparatus that comprises a list of elements is not necessarily limited to those elements, but may include other elements not expressly listed or inherent to such process, method, system, article, device, or apparatus.

### DETAILED DESCRIPTION OF EXEMPLARY EMBODIMENTS

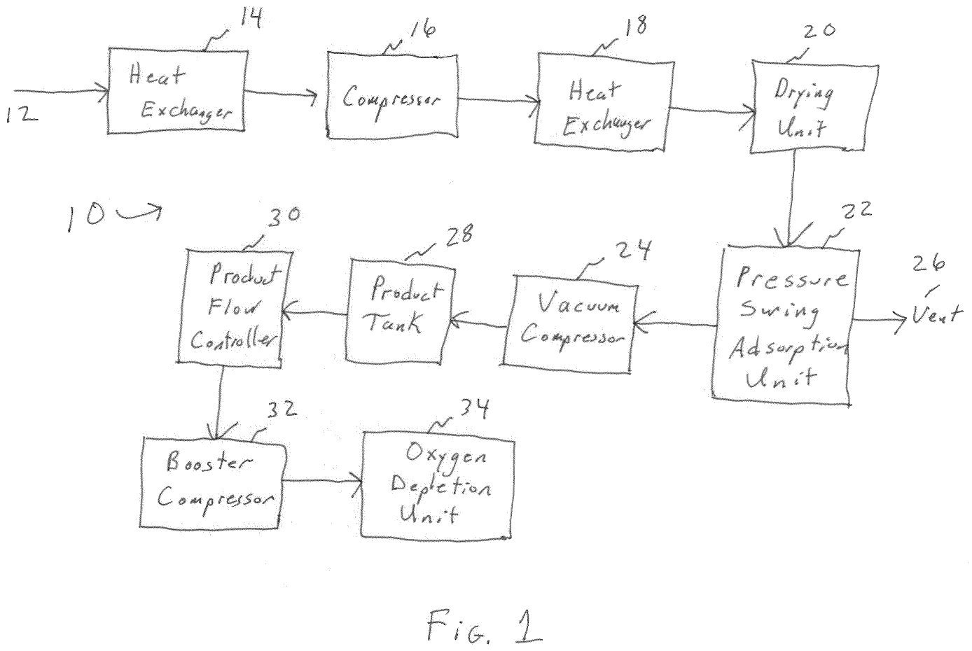

FIG. 1 is a schematic view of a CO2 separating system 10 into which feed gas 12 is received for processing. The feed gas 12 is received by a heat exchanger 14 that uses ambient air to cool the hot feed gas 12. The cooled gas is then provided to a compressor 16, for example a screw feed compressor, to boost the pressure of the gas from atmospheric pressure to a higher pressure, for example about between 80 and 100 psi. The compressor 16 may be paired with a second heat exchanger 18 to cool the compressed gas and to remove any water moisture from the compressed gas.

The system 12 further includes a drying unit 20 for removing water from the cooled compressed gas. The drying unit 20 may be a pressure swing adsorption system that includes two or more adsorption towers with each having a desiccant media to remove water by adsorption. The drying unit 20 may alternate placing one of the adsorption towers in operation while another adsorption tower may undergo a regeneration process.

The dried gas is then fed to a pressure swing adsorption unit 22 for separating CO2 from the dried, cooled compressed gas. The pressure swing adsorption unit 22 preferably uses a carbon or synthetic adsorption media tailored to adsorb CO2 as the gas passes through the media under high pressure due to the different molecular size of the gases contained in the feed gas. In one embodiment, the adsorption media may be Molecular Gate adsorbent available from Guild Associates, Inc. The adsorption unit 22 may include two or more adsorbent vessels with one in an adsorption mode while the other vessels are regenerated by swinging the media to low pressure. A vacuum compressor 24, such as a screw compressor, may be used to pull the adsorbed CO2 off the adsorption media. The gases separated from the CO2 may be exhausted from vent 26.

The CO2 may be temporarily stored in a product tank 28 that aids in reducing the pulsating flow from switching between the adsorbent vessels creating a generally steady flow rate of CO2. The CO2 removal system 10 may include a product flow controller 30, including a computer-controlled valve to regulate the flow of gases through the pressure swing adsorption unit 22.

The removal system 10 may include a booster compressor 32, such as a screw compressor, for extracting the CO2 from the product tank 28 and boosting the pressure of the CO2 gas. The booster compressor 32 may increase the pressure of the CO2 gas from less than 5 psi to about 90-120 psi.

Optionally, the removal system 10 may include an oxygen depletion unit 34 that uses a combustible gas such as methane or hydrogen fed through a catalyst, preferably a platinum catalyst. In the oxygen depletion unit 34, the oxygen will mix with hydrogen to form water to cause the CO2 gas to be removed of the remaining oxygen. Preferably, the CO2 gas will include less than 10 ppm of oxygen. The water may then be removed using a drying unit.

In one embodiment, the feed gas may have a flow rate of about 59,000 SCFM measured at a pressure of about 0.54 PSIG (15.24 PSIA) at a temperature of about 185 F. The feed gas may include about 66.7 percent nitrogen by volume, 12.7 percent CO2 by volume, 2.5 percent oxygen by volume, and 18.1 percent water by volume.

After exiting the drying unit 20, the gas may have a flow rate of about 48,326 SCFM measured at a pressure of about 100 PSIG (114.7 PSIA) at a temperature of about 150 F. At this stage, the gas may include about 81.43 percent nitrogen by volume, 15.51 percent CO2 by volume, 3.05 percent oxygen by volume, and a negligible amount of water (<5 lbs/MMscf).

After exiting the booster compressor 32, the gas may have a flow rate of about 7,638 SCFM measured at a pressure of about 100 PSIG (114.7 PSIA) at a temperature of about 115 F. At this stage, the gas may include about 3.86 percent nitrogen by volume, 95.93 percent CO2 by volume, 1448 ppm oxygen, and a negligible amount of water (<30 lbs/MMscf).

After exiting the oxygen depletion unit 32, the gas may have a flow rate of about 7,622 SCFM measured at a pressure of about 90 PSIG (104.7 PSIA) at a temperature of about less than 120 F. At this stage, the gas may include about 3.87 percent nitrogen by volume, 96.13 percent CO2 by volume, less than 10 ppm oxygen, and a negligible amount of water (<30 lbs/MMscf).

The vented gas may have a flow rate of about 40,688 SCFM measured at a pressure of about 0 PSIG (14.7 PSIA) at a temperature of about less than 120 F. At this stage, the gas may include about 95.99 percent nitrogen by volume, 0.41 percent CO2 by volume, 3.6 percent oxygen by volume, and a negligible amount of water (<5 lbs/MMscf).

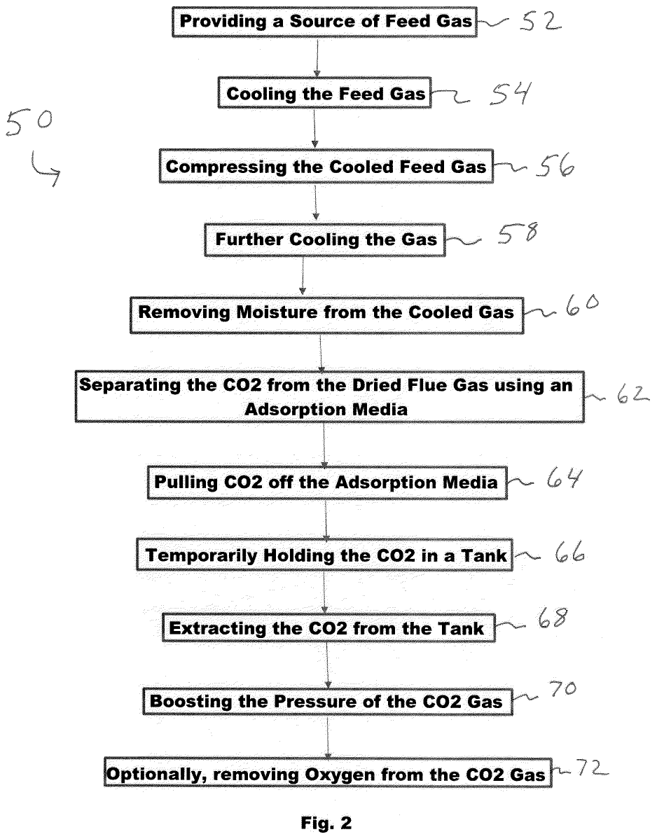

FIG. 2 illustrates is a method 50 for separating CO2 from flue gas. The method 50 includes providing a source of feed gas (step 52), cooling the feed gas (step 54), compressing the cooled feed gas (step 56), further cooling the gas (step 58), and then removing moisture from the cooled gas to generate a dried flue gas (step 60). The method continues by separating the CO2 from the dried flue gas using a pressure swing adsorption unit for adsorbing CO2 from the dried, cooled compressed gas using an adsorption media (step 62), and using a vacuum compressor for pulling the CO2 off the adsorption media (step 64), temporarily holding the CO2 from the vacuum compressor in a tank (step 66) and then extracting the CO2 from the tank (step 68) and boosting the pressure of the CO2 gas (step 70). The method may further include the optional step of substantially removing oxygen from the CO2 gas (step 72).

While various novel features of the invention have been shown, described, and pointed out as applied to particular embodiments thereof, it should be understood that various omissions, substitutions and changes in the form and details of the systems and methods described and illustrated may be made by those skilled in the art without departing from the spirit of the invention. Amongst other things, the steps shown in the methods may be carried out in different orders in many cases, where such may be appropriate. Those skilled in the art will recognize, based on the above disclosure and an understanding therefrom of the teachings of the invention, that the particular hardware and devices that are part of the system described herein, and the general functionality provided by and incorporated therein, may vary in different embodiments of the invention. Accordingly, the particular system components are for illustrative purposes to facilitate a full and complete understanding and appreciation of the various aspects and functionality of particular embodiments of the invention, as realized in system and method embodiments thereof. Those skilled in the art will appreciate that the invention can be practiced in other than the described embodiments, which are presented for purposes of illustration and not limitation.

What is claimed is:

1. A system for separating CO2 from flue gas comprising:
a first heat exchanger for receiving and cooling the flue gas;
a compressor for increasing the pressure of the cooled gas;
a second heat exchanger to further cool the compressed gas;
a drying unit for removing water from the cooled compressed gas;
a pressure swing adsorption unit for adsorbing CO2 from the dried, cooled compressed gas using an adsorption media, the adsorption unit comprising a vacuum compressor for pulling the CO2 off the adsorption media;
a tank for temporarily holding the CO2 from the vacuum compressor;
a controller to regulate the flow of gas from the adsorption unit; and
a compressor for extracting the CO2 from the tank and boosting the pressure of the CO2 gas.

2. The system of claim 1 further comprising a vent for exhausting gases

3. The system of claim 1 wherein the pressure swing adsorption unit comprises at least two vessels wherein one of the vessels can be regenerated while the other vessel is in operation.

4. The system of claim 1 wherein the dryer comprises a first and a second adsorption tower each having a desiccant media wherein the second adsorption tower may be regenerated while the first adsorption tower is in operation.

5. The system 10 further comprising an oxygen depletion unit to cause the CO2 gas to be substantially removed of any remaining oxygen.

6. A method for separating CO2 from flue gas comprising the steps of:
providing a source of feed gas;
cooling the feed gas;
compressing the cooled feed gas;
further cooling the gas;
removing moisture from the cooled gas to generate a dried flue gas;
separating the CO2 from the dried flue gas using a pressure swing adsorption unit for adsorbing CO2 from the dried, cooled compressed gas using an adsorption media, and using a vacuum compressor for pulling the CO2 off the adsorption media;
temporarily holding the CO2 from the vacuum compressor in a tank;
extracting the CO2 from the tank and boosting the pressure of the CO2 gas.

7. The method of claim 6 wherein the step of compressing the cooled feed gas comprises the step of increasing the pressure of the cooled feed gas.

8. The method of claim 6 further comprising the step of substantially removing oxygen from the CO2 gas.
